(19) United States
(12) Patent Application Publication
(10) Pub. No.: US 2011/0138028 A1
(43) Pub. Date: Jun. 9, 2011

(54) Managing Networking Events

(76) Inventors: Noah Katz, New York, NY (US); Daniel Katz, Stamford, CT (US)

(21) Appl. No.: 12/960,719

(22) Filed: Dec. 6, 2010

Related U.S. Application Data
(60) Provisional application No. 61/266,855, filed on Dec. 4, 2009.

(51) Int. Cl. G06F 15/173

(52) U.S. Cl. 709/223

(57) ABSTRACT

Methods and systems for managing networking events are provided. An application for managing networking events may be provided to a mobile device. The application may or may not include information regarding a particular networking event. Such information may be imported, downloaded, or entered by a user. The user may prepare for the networking event by creating a customized agenda including the particular activities and tasks that are of interest to the user. While the user is at the networking event and participating in such activities or tasks, the user may add information to an entry regarding such activity or task. Such information may be saved and later used to generate a report, which may be published on a social media site.

### CROSS-REFERENCE TO RELATED APPLICATIONS

The present application claims priority to U.S. provisional patent application 61/266,855 filed Dec. 4, 2009, the disclosure of which is incorporated herein by reference.

### BACKGROUND

1. Field of the Invention

The present invention generally relates to managing data. More specifically, the present invention relates to managing networking events.

2. Description of the Related Art

While the use of computerized social networks has become prevalent in recent years, live networking continues to provide unique opportunities to meet and gather information from various sources. Examples of networking events where such live networking regularly occurs include trade shows, industry events, recruiting events, etc. Complications related to getting value from attendance at live networking events include issues regarding tracking information received, tracking the particular tasks preparing for the networking event, performed during the networking event, and reporting on the same.

Presently existing tools are ill-equipped to handle the different types of information related to managing a networking event. While calendars may record the date and time of appointments, for example, calendars are generally not equipped to maintain multimedia information received during a particular appointment. Contacts databases and to-do lists are similarly lacking. Further, the aforementioned tools generally all fail to correlate the tasks, contacts, and multimedia information to the general networking event. For example, attendance at a particular trade show may include appointments with multiple contacts, at different locations, with different preparation tasks required beforehand, and different information received from each contact.

There is, therefore, a need to improved systems and methods for correlating information related to networking events.

### SUMMARY OF THE INVENTION

Embodiments of the present invention include methods and systems for managing networking events. An application for managing networking events may be provided to a mobile device. The application may or may not include information regarding a particular networking event. Such information may be imported, downloaded, or entered by a user. The user may prepare for the networking event by creating a customized agenda including the particular activities and tasks that are of interest to the user. While the user is at the networking event and participating in such activities or tasks, the user may add information to an entry regarding such activity or task. Such information may be saved and later used to generate a report, which may be published on a social media site.

Such a networking event may commence with transferring an application for managing network events over a communication network to the mobile device. In such an application, each activity associated with network events is associated with a form of information entries. Methods may further include receiving a request from the mobile device concerning information related to a specified networking event and transferring the requested information over the communication network to the mobile device. The requested information may include an agenda for the specified networking event including specified activities. Such information (including the agenda) may be synchronized with the memory of the mobile device. In the application, a form of information entries may be generated for each specified activity indicated by the transferred agenda, and information missing from the transferred agenda may be identified based on finding empty information entries in the forms. Subsequently, a request may be sent to the user of the mobile device to enter the information identified as missing. Based on the user response, a gameplan may be generated for the specified networking event.

When the user is at the event, methods for managing networking events using the mobile device may further include receiving input associated with a specified networking event and a plurality of specified tasks (e.g., in the gameplan), maintaining the received input in a log, synchronizing information between the log and the memory of the mobile device, and generating a report concerning the networking event, the report including the information maintained in the log. The report may be published or distributed in various forms, including as a slide presentation and/or a webpage.

In further embodiments of the present invention, computer-readable storage media is provided. Embodied on such computer-readable storage media may be a program that is executable by a processor to perform a method for managing networking events.

### BRIEF DESCRIPTION OF THE DRAWINGS

FIG. 1 illustrates a network digital environment 100 in which a system for managing networking events may be implemented.

FIG. 2 is a flowchart illustrating an exemplary method 200 for managing networking events.

### DETAILED DESCRIPTION

In an exemplary embodiment of the present invention, the user of a mobile device requests creation of a log for tracking information related to a particular networking event. The user may either enter the name of the networking event or refer to a calendar entry for the name, date, and time of the event. Once the log is created, the user may choose to access various types of entries in order to enter the appropriate information. For example, the user may designate certain overall goals and identify various tasks for accomplishing each goal.

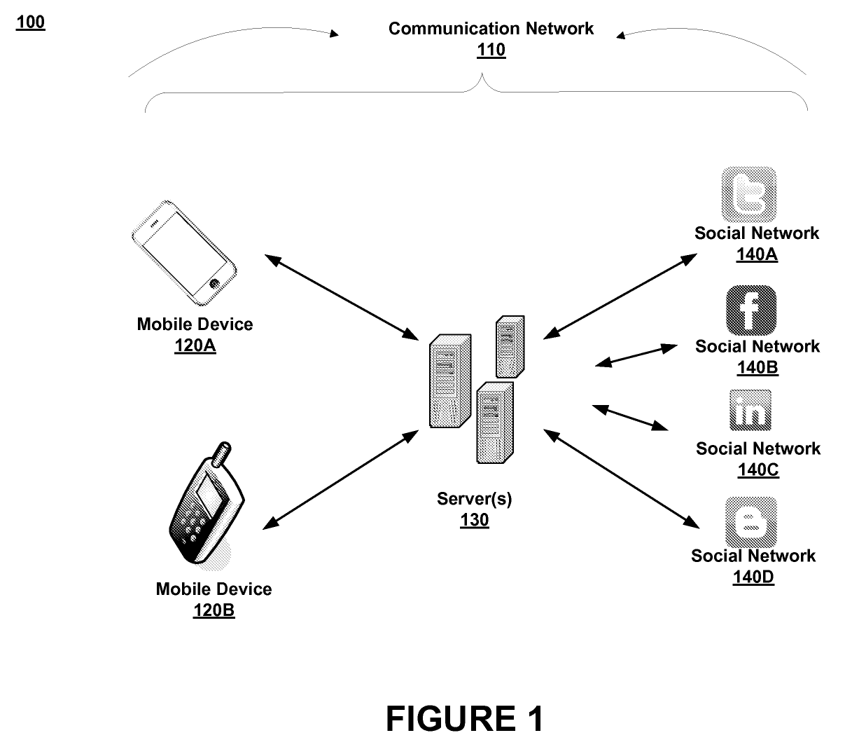

FIG. 1 illustrates a network digital environment 100 in which a system for managing networking events may be implemented. Communicating via communication network 110, users of mobile devices 120A-120B communicate with one or more servers 130, which may further interact with various social media sites 140A-140D.

Communication network 110 may be inclusive of any local, proprietary network (e.g., an intranet), as well as any larger wide-area network. The communications network 110 may include a local area network (LAN), for example, which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network 110 allows for communication between the various components of digital environment 100.

Mobile devices 120 may communicate through communication network 110 using any number of different electronic client or end-user devices including mobile devices 120 such as a cellular phone, smartphone, a personal digital assistant (PDA), as well as a netbook (i.e., a miniature laptop computing device).

One or more servers 130 can receive information from mobile devices 120 and may further communicate part or all of such information to one or more recipients. Servers 130 may include any computing device as is known in the art, including standard computing components such as network and media interfaces, non-transitory computer-readable storage (memory), and processors for executing instructions or accessing information that may be stored in memory. The functionalities of multiple servers may be integrated into a single server. Any of the aforementioned servers (or an integrated server) may take on certain client-side, cache, or proxy server characteristics. These characteristics may depend on the particular network placement of the server or certain configurations of the server.

A possible recipient of information from servers 130 may be a social media site 140 (e.g., Twitter®, Facebook®, LinkedIn®, Blogger®). Social media sites 140 generally allow entities to become members and publish information. Such published information may include photographs, video, textual information (e.g., status updates, hyperlinks, bookmarks, blogs, microblogs, articles, forum posts, comments), and further interactions (e.g., games, member interaction, chatting). Social media sites 140 further allow for members to interact with the media content on the sites and provide information regarding their daily activities, political views, cravings, product complaints, family issues, and general interests and musings.

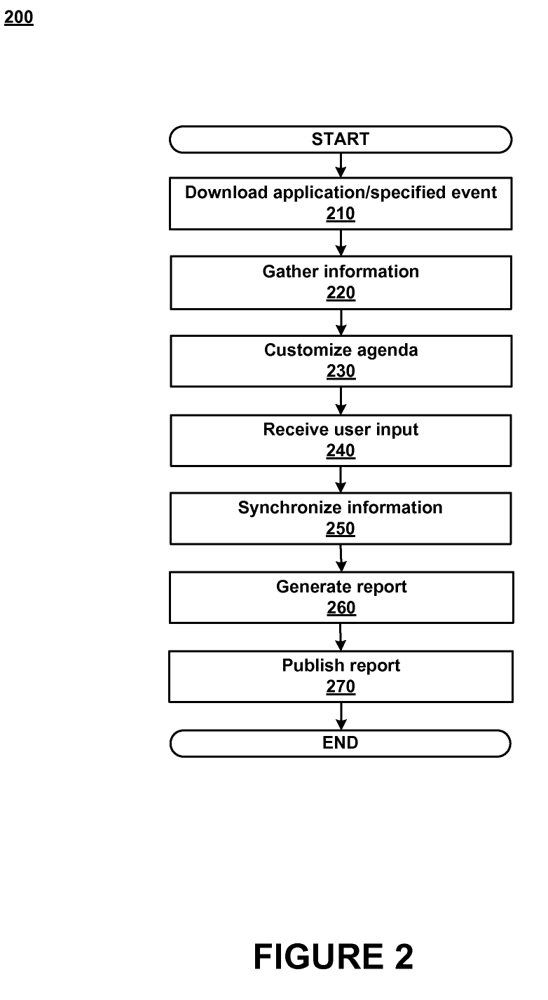

FIG. 2 is a flowchart illustrating an exemplary method 200 for managing networking events. In the method, an application may be downloaded to a mobile device, information regarding a particular specified networking event is gather, an agenda is customized, and user input is received regarding certain activities or tasks. Information is synchronized between the application and a memory of the mobile device (which may be used to further share the information with other applications on the mobile device). A report regarding the event may be generated and published in various forms.

In step 210, an application may be downloaded to a mobile device 120. Such an application may be downloaded over the Internet, from an application store (e.g., iTunes® AppStore), or by another method known to those in the art. The application may or may not be specific to a particular event. For example, the application may be a general tool that may be used with any networking event. Alternatively, the application may be specific to a particular networking event (e.g., Consumer Electronics Show (CES), Electronic Entertainment Expo (E3), Comic-Con). In such instances, the application may already include an initial agenda indicating a schedule of events, workshops, seminars, panels, performances, demonstrations, meetings, etc. Other information specific to a particular event may further include a map and/or direction of the location. Such a map and/or direction may indicate the locations of the various items on the agenda, as well as other participants in the networking event (e.g., vendor map/directory, booth map/directory). In some instances, a general application may be downloaded to a mobile device, and another application (or information packet) may be downloaded to tailor the general application for use with a particular networking event.

In some embodiments, the application may include a form that may be filled out with information related to each activity or agenda item. For example, a particular seminar may be associated with a form having entries for the date, time, location, speaker and/or attendee names, speaker/attendee contact information, goals, notes, and follow-up action items. Additional entries may also be added (e.g., by the user, by a developer, by an administrator) to further tailor the application to the networking event. For example, an activity form for CES may include an entry for type of electronics. Similarly, an activity form for E3 may include an entry for game platform, game title, type of game controller, and whether the game is in 3D, multiplayer, etc.

In step 220, additional information may be gathered to prepare for the networking event. Such information may be gathered automatically, upon prompt by a user, or may require the user to enter at least part of the information. For example, a panel listing a speaker may not list any contact information for the speaker. The information may be identified as missing from an empty field in the form associated with the panel. As such, a search for the missing information may be initiated.

The search may occur on the mobile device (e.g., looking up speaker name in contact database), on the internet, on a particular site associated with the particular networking event, etc. For example, the application may obtain information from and share information with a calendar, contacts database, GPS/map module, etc., available on the mobile device of the user. Information that is already entered or synchronized in a particular entry of the log may further be available for reference in other entries of the log. For example, contacts entered with reference to a seminar may also be available in a menu when scheduling meetings. The user may simply designate the contacts required from the menu rather than entering manually or retrieving after a search. Some missing information may also be filled in during the networking event. Such information may form at least of the user input described in further detail with respect to step 240.

In step 230, a customized agenda concerning the networking event may be generated for the user of the mobile device 120. Such an agenda may be part of a larger gameplan that includes preparatory tasks, interstitial tasks, and follow-up tasks. Some agenda items, as well as the aforementioned tasks, may be set by default, associated with a particular activity in the networking event, or may be set in full or in part by the user. In preparation for the networking event, for example, the user may identify preparatory tasks to be performed ahead of the actual networking event. The tasks may involve booking airline tickets, hotel rooms, identifying contacts to meet at the event, and the desired information from each contact.

Similar information sharing may occur with respect to the customized agenda, as with respect to step 220. An exemplary entry for a task may refer to making an appointment to meet with a particular contact, or scheduling a seminar/workshop. The appointment may be imported from, or exported to the calendar. As such, reminders may also be provided to the user in a familiar and convenient form, as with any other calendar appointment. Similarly, the contact information or location information may be imported from, or exported to the contacts database, GPS/map module, social media applications, etc., on the mobile phone 120.

The information entered in the preparation phase may also be used to generate checklists of specified tasks, which may be defined by default, based on the networking event, and/or on user specifications. For example, a checklist related to a CES workshop may include obtaining names of the demo participants, contact information, affiliated companies, etc. Such checklists may be referred to during the networking event to ensure that all information and tasks are gathered and recorded fully and properly.

Tasks encompassed by a particular networking event may include meetings (impromptu or by appointment), making off-site visits, rehearsing a talk, obtaining samples, brochures, etc. Each task may be associated with a particular form for entering information (e.g., notes, goals, follow-up action items). Such recorded information may further be stored and organized in association with the particular activity or task.

In some embodiments, a suggested agenda entry may be generated based on information entered. Referring to the above example, an appointment with a particular contact may be automatically generated and presented as a suggestion to the user once the contact information is entered.

In step 240, a user may enter or otherwise provide information to the mobile device during the event. For example, the user may photograph or scan a business card, and the information on the business card may be automatically translated (e.g., optical character recognition (OCR), other text recognition) and populated to the appropriate entries. Other ways to enter information may be via voice recording/recognition, infrared (IR) communication, using a cable, using a wireless connection (e.g., Bump®), and other methods of communication and information entry as known in the art.

Information may be in the form of text, photographs, video, and any type of file that may be captured by and/or communicated to a mobile device 120. Information may be gathered through use of keyboards, keypads, touchscreens, cameras, sensors, scanners, and other detection devices known in the art. Coupled with recognition software, which may be continually refined, such tools may capture information that may be used to fill out the form and/or complete a task.

In step 250, information may be synchronized between the application and another database. The database may be stored in memory of the mobile device 120. Such database may be accessible to other applications on the mobile device 120. In some embodiments, certain information may be automatically synchronized with another application. For example, contact information may be automatically synchronized between the application and the native contact database of the mobile device 120. In addition, information from the application regarding the networking event may be synchronized with a server (e.g., server 130). Such synchronization may be ongoing, occur automatically, periodically, or triggered by a specified act or event.

In step 260, a report is generated by mobile device 120 or by server 130. In some instances, server 130 may receive a report from mobile device 120 and generate additional reports. Following a networking event, a user may wish to generate a report of the networking event, either for his/her records or for others. The report may be generated as a slideshow presentation (e.g., PowerPoint®), as a written report, a checklist for follow-up tasks, etc. The ability for a single individual to generate a comprehensive report allows the information in the report to be propagated to others. As such, a business can maximize the value of a single individual's attendance at such an event while minimizing the disruption and productivity loss that may otherwise result from sending multiple employees.

In some embodiments, the report may be generated automatically as a slideshow presentation and sent to one or more designated recipients. The particular from of the reports may depend on the purpose of the report. Such purposes may include research, planning, marketing, etc. In some cases, servers 130 may export such reports as a file (e.g., Microsoft Word®, Excel®, PDF, XML, JSON, SMS, email) to a recipient automatically, periodically, and/or upon request. The particular parameters for aggregating, organizing, and formatting such exported data may be specified by the specific recipient requesting such information.

In some cases, the recipient is a site for publication (e.g., social media site 140). In step 270, the report is published. Publication may involve creating a page on a social media site 140 for publication, as well as submission of a report in the appropriate form for the social media site 140. A report to a social media site 140 may also include data that is not published, but that may be used on such social media site 140. For example, information regarding individuals that the user met during the networking event may be used to determine whether such individuals are members of the social media site 140. Invitations may be sent to such individuals to join the social media site 140 and/or to join the particular social network associated with the user, and vice versa (e.g., the user requests to join the social network associated with such individuals).

The present invention may be implemented in an application that may be operable using a variety of end user devices. The present methodologies described herein are fully intended to be operable on a variety of devices. The present invention may also be implemented with cross-title neutrality wherein an embodiment of the present system may be utilized across a variety of titles from various publishers.

Computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method for managing networking events, the method comprising:
transferring an application for managing network events over a communication network to the mobile device, wherein each activity associated with the network events is associated with a form of information entries;
receiving a request for information over a communication network, the request concerning information related to a specified networking event; and
transferring information over a communication network to the mobile device, the information including an agenda for the specified networking event, the agenda indicating a plurality of specified activities, wherein execution of the application by a processor of the mobile device:
synchronizes information between the transferred agenda and the memory of the mobile device,
generating a form of information entries for each specified activity indicated by the transferred agenda,
identifies information missing from the transferred agenda based on finding empty information entries in the form,
generates a request to a user of the mobile device to enter the information identified as missing, and
generates a gameplan for the specified networking event, the gameplan concerning one or more of the specified activities.

2. The method of claim 1, wherein the gameplan includes a checklist of tasks and wherein execution of further instructions by the processor generates a custom agenda for the user of the mobile device based on user selections on the checklist.

3. The method of claim 1, wherein at least one of the tasks includes gathering information and wherein the user of the mobile device inputs information designated as associated with the task.

4. The method of claim 3, wherein the inputted information is selected from the group consisting of text, photograph, voice recording, and video recording.

5. The method of claim 1, wherein execution of further instructions by the processor matches each specified activity to an entity participating in the networking event, the entity associated with a location indicated by a map or directory and generates a visual display indicating relative locations of the entities matched to the specified activities.

6. The method of claim 1, further comprising:
receiving a report from the mobile device, the report including information regarding progress on the gameplan; and
transmitting the report to one or more designated recipients.

7. The method of claim 6, further comprising creating a webpage for the networking event and publishing the transmitted report on the webpage.

8. A method for managing networking events, the method comprising:
receiving input via a user interface of a mobile device, the input associated with a specified networking event, the specified networking event associated with a plurality of specified tasks;
maintaining the received input in a log concerning the specified networking event, the log being maintained in a memory of the mobile device; and
executing instructions stored in memory, wherein execution of the instructions by a processor of the mobile device:
synchronizes information between the log and the memory of the mobile device, and
generates a report concerning the networking event, the report including the information maintained in the log.

9. The method of claim 8, wherein input is selected from the group consisting of text, photograph, voice recording, and video recording.

10. The method of claim 8, further comprising generating a checklist regarding the specified tasks, wherein the user generates the input in response to the checklist of specified tasks.

11. The method of claim 8, further comprising receiving information regarding an additional task from the user and adding a checklist item regarding the additional task to the checklist.

12. The method of claim 8, wherein generating the checklist includes querying the user regarding one or more goals.

13. The method of claim 8, wherein each specified task on the checklist is associated with a location on a map and wherein an order of the specified tasks on the checklist is based on the map location associated with each specified task.

14. The method of claim 13, further comprising:
receiving a map or directory indicating locations of a plurality of entities participating the networking event;
matching each specified task to one of the entities participating in the networking event; and
generating a visual display indicating relative locations of the entities matched to the specified tasks.

15. The method of claim 8, wherein the generated report includes a slide presentation concerning the networking event.

16. The method of claim 8, further comprising creating a webpage for the networking event and publishing the report on the webpage.

17. The method of claim 8, further comprising synchronizing information between the log and another application on the mobile device, the other application selected from the group consisting of calendar, contacts, notes, maps, photos, and social networks.

18. The method of claim 17, wherein synchronizing information between the log and the other application includes synchronizing the other application with the synchronized information stored in the memory of the mobile device.

19. The method of claim 8, wherein the input is associated with an action item and a priority of the action item, the action item and priority designated by a user of the mobile device, and further comprising generating a list of action items in order of the priority.

20. A non-transitory computer-readable storage medium, having embodied thereon a program, the program being executable by a processor to perform a method for managing networking events, the method comprising:
transferring an application for managing network events over a communication network to the mobile device, wherein each activity associated with the network events is associated with a form of information entries;
receiving a request for information over a communication network, the request concerning information related to a specified networking event; and
transferring information over a communication network to the mobile device, the information including an agenda for the specified networking event, the agenda indicating a plurality of specified activities, wherein execution of the application by a processor of the mobile device:
synchronizes information between the transferred agenda and the memory of the mobile device,
generating a form of information entries for each specified activity indicated by the transferred agenda,
identifies information missing from the transferred agenda based on finding empty information entries in the form,
generates a request to a user of the mobile device to enter the information identified as missing, and
generates a gameplan for the specified networking event, the gameplan concerning one or more of the specified activities.

21. A non-transitory computer-readable storage medium, having embodied thereon a program, the program being executable by a processor to perform a method for managing networking events, the method comprising:
receiving input associated with a specified networking event, the specified networking event associated with a plurality of specified tasks;
maintaining the received input in a log concerning the specified networking event;
synchronizing information between the log and a memory of a mobile device; and
generating a report concerning the networking event, the report including the information maintained in the log.
